(19) United States
(12) Patent Application Publication
(10) Pub. No.: US 2016/0290192 A1
(43) Pub. Date: Oct. 6, 2016

(54) TWO-STROKE COMPRESSION IGNITION ENGINE

(71) Applicant: Ta-Jen HUANG, Hsinchu City (TW)

(72) Inventor: Ta-Jen HUANG, Hsinchu City (TW)

(21) Appl. No.: 15/078,684

(22) Filed: Mar. 23, 2016

(30) Foreign Application Priority Data
Apr. 1, 2015 (TW) 104110625

(51) Int. Cl. F01M 11/08; F02B 33/04; F01M 9/06; F02M 37/04

(52) U.S. Cl. CPC F01M 11/08; F02M 37/04; F02B 33/04; F01M 9/06

(57) ABSTRACT

A two-stroke compression ignition engine includes a casing, a fuel supply unit, a rotary unit, a piston, lubrication oil and an oil baffle. The casing includes an end portion, a cylinder chamber, a crankshaft chamber, an intake port, an exhaust port and a bypass. The fuel supply unit is provided at the end portion and used for supplying fuel into the cylinder chamber. The intake port is used for supplying air into the cylinder chamber. The air within the cylinder chamber is compressed and then heated to become high-temperature air during the movement of the piston toward top dead center. The fuel is ignited by the high-temperature air to produce an explosion to drive the piston for a reciprocating motion. The oil baffle is provided for passing the air while blocking the lubrication oil from entering the bypass. Thus it ensures the air entering the cylinder chamber is clean.

### FIELD OF THE INVENTION

The present invention is related to a two-stroke engine, particularly to a two-stroke compression ignition engine ignited through compressing air.

### BACKGROUND OF THE INVENTION

An engine, also known as an internal combustion engine, is one of indispensable devices of transportation (such as motorcycles, automobiles and vessels), and capable of moving transportation to obtain the effect of transit by the application of principle and operation of transformation of chemical energy into mechanical energy. The operation in one cycle is basically divided into four stages as follows: intake, compression, ignition and exhaust. A means accomplishing the aforementioned cycle in two strokes is called a two-stroke cycle, and an engine employing the two-stroke cycle is called a two-stroke engine. In a similar way, an engine accomplishing the aforementioned cycle in four strokes is then called a four-stroke engine.

In comparison with the four-stroke engine, merits including simple design, low cost, more power cycles per unit time and so on are inherent in the two-stroke engine. The conventional two-stroke engine is illustrated in Taiwan Patent No. 1407008, entitled “Intake and Exhaust Disc Piston Two-Stroke Three Cylinder Petrol Engine”, for example. It discloses a two-stroke engine formed with in-line three cylinders, each of which comprises a cylinder block, an intake hole, a non-return valve, a hydraulic cylinder, a disc piston, an exhaust hole and a crank web. The intake hole, the hydraulic cylinder and the disc piston are located in the upper part of the cylinder block. The disc piston is capable of separating exhaust from combustible gas mixture. The non-return valve is located beside the intake hole. The exhaust hole is located in the lower part of the cylinder block. An explosion is produced by igniting the compressed combustible gas mixture with a spark plug, for pushing the disc piston and then achieving an up-and-down movement with the aid of the crank web. In this case, the angle of crank web of the first cylinder is in a range of 0 to 360 degrees. The angle of crank web of the second cylinder in relation to the angle of crank web of the first cylinder is 120 degrees. The angle of crank web of the third cylinder in relation to the angle of crank web of the second cylinder is 120 degrees, while that in relation to the angle of crank web of the first cylinder is 240 degrees. Thus, it can be seen that the two-stroke cycle of each of the three cylinders is carried out and accomplished, respectively, in sequence.

In the conventional two-stroke petrol engine, however, exhaust and intake take place at the same time, as well as the exhaust hole and the intake hole are communicated with each other. As a result, the combustible gas mixture is expelled in part through the exhaust hole during intake, which causes the problem of high levels of pollution.

Besides, lubrication is achieved by mixing lubrication oil with the combustible gas mixture. In this case, lubrication oil is also expelled through the exhaust hole, which leads to more serious air pollution.

### SUMMARY OF THE INVENTION

It is the primary object of the present invention to solve the problem of high levels of pollution inherent in the conventional two-stroke petrol engine.

To solve the above problem, the present invention provides a two-stroke compression ignition engine, comprising a casing, a fuel supply unit, a rotary unit, a piston, lubrication oil and an oil baffle. The casing comprises an end portion, a cylinder chamber, a crankshaft chamber, an intake port, an exhaust port and a bypass. The cylinder chamber, defining a chamber axis, is located near the end portion. The crankshaft chamber is connected with the cylinder chamber. The intake port is communicated with the crankshaft chamber, so as to supply air into the crankshaft chamber. The exhaust port is communicated with the cylinder chamber. The bypass is provided with two ends communicated with the crankshaft chamber and the cylinder chamber, respectively, and comprises a communication port communicated with the crankshaft chamber, in such a way that the air is possibly allowed to enter the cylinder chamber via the crankshaft chamber and the bypass. The fuel supply unit is provided at the end portion and used for supplying fuel into the cylinder chamber. The rotary unit is accommodated within the crankshaft chamber, and composed of a rotating part as well as a linkage. The linkage is pivotally connected with the rotating part and moved therewith.

The piston is located within the cylinder chamber, and pivotally connected with the linkage. Moreover, the piston is subjected to a reciprocating motion along the chamber axis between a top dead center (TDC) closest to the end portion and a bottom dead center (BDC) farthest away from the end portion. Further, the air within the cylinder chamber is compressed and then heated to become high-temperature air during the movement of the piston toward the TDC. The fuel is supplied to the cylinder chamber by the fuel supply unit as the piston reaches the TDC, and then ignited by the high-temperature air to produce an explosion to drive the piston for the reciprocating motion. The lubrication oil is accommodated within the crankshaft chamber. The lubrication oil provides lubrication required for the piston on reciprocating motion and the rotary unit via a lubrication oil delivery mechanism. The oil baffle is provided at the communication port for passing the air while blocking the lubrication oil from entering the bypass, so as to prevent the lubrication oil from flowing to the cylinder chamber along with the air and then ensure that the air entering the cylinder chamber is clean.

In conclusion, the characteristic of igniting fuel by high-temperature air due to compression is used by the present invention. Furthermore, the piston is driven for the reciprocating motion, even though the combustible gas mixture is rejected. In this case, the problem of pollution by the combustible gas mixture never takes place, although the air is also partly expelled through the exhaust port. In addition, the oil baffle prevents the lubrication oil from flowing to the cylinder chamber along with the air and thus the problem of pollution by the lubrication oil will not take place. Besides, enhanced fuel efficiency far higher than that of the conventional two-stroke petrol engine is also achieved for the two-stroke compression ignition engine of the present invention, due to fuel efficiency of the conventional four-stroke compression ignition engine (such as diesel engine) being far higher than that of the spark-ignition engine (such as traditional petrol engine).

### BRIEF DESCRIPTION OF THE DRAWINGS

FIG. 1A is a cross-section diagram of a piston at top dead center according to one embodiment of the present invention.

FIG. 1B is a cross-section diagram of a piston at bottom dead center according to one embodiment of the present invention.

### DETAILED DESCRIPTION OF THE PREFERRED EMBODIMENTS

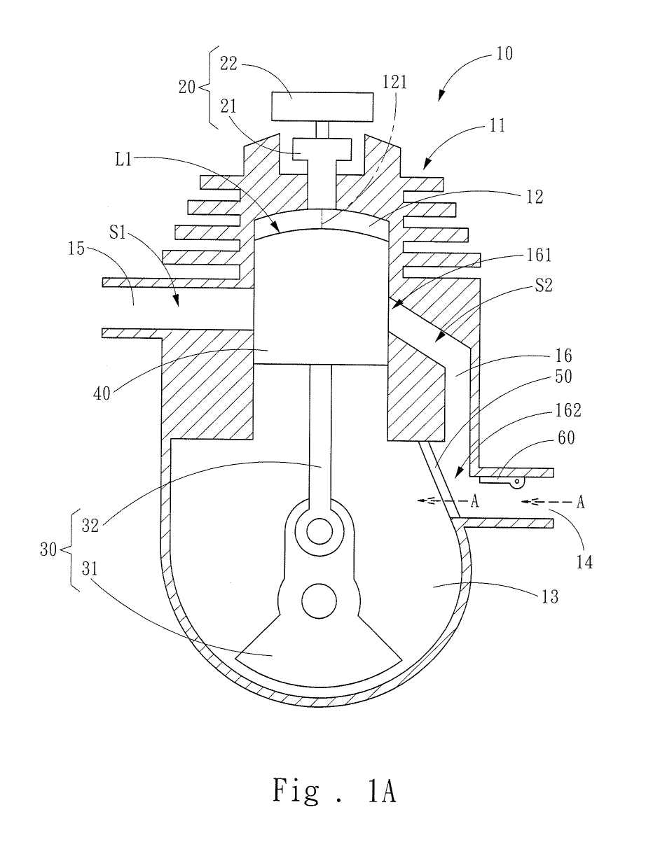

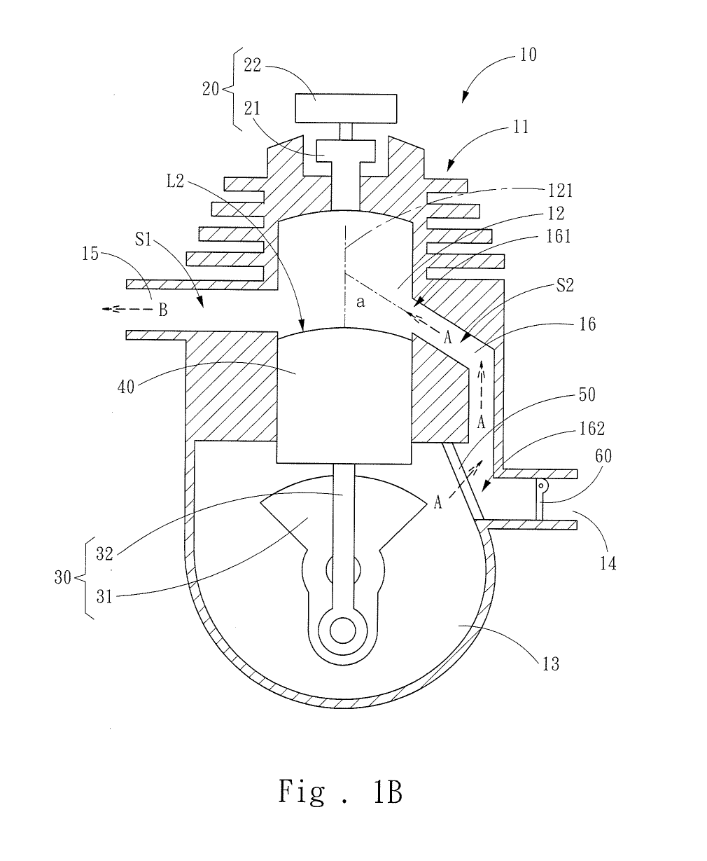

Now, the detailed description and technical contents in respect of the present invention will be illustrated hereinafter in combination with drawings. Referring to FIG. 1A, which is a cross-section diagram of a piston at top dead center (TDC) according to one embodiment of the present invention. As illustrated in the figure, the present invention is direct to a two-stroke compression ignition engine, comprising a casing 10, a fuel supply unit 20, a rotary unit 30, a piston 40, an oil baffle 50, a throttle valve 60 and lubrication oil. The casing 10 includes an end portion 11, a cylinder chamber 12, a crankshaft chamber 13, an intake port 14, an exhaust port 15 and a bypass 16. The cylinder chamber 12, defining a chamber axis 121, is located near the end portion 11. The crankshaft chamber 13 is connected with the cylinder chamber 12. The intake port 14 is communicated with the crankshaft chamber 13, so as to supply air (A) into the crankshaft chamber 13. The exhaust port 15 is located at an exhaust side (S1) with respect to the chamber axis 121, and communicated with the cylinder chamber 12. The bypass 16 is located at an intake side S2 opposite to the exhaust side S1 with respect to the chamber axis 121, and provided with two ends communicated with the crankshaft chamber 13 and the cylinder chamber 12, respectively, in such a way that the air (A) is possibly allowed to enter the cylinder chamber 12 via the crankshaft chamber 13 and the bypass 16. The bypass 16 comprises a scavenge port 161 and a communication port 162. The scavenge port 161 is communicated with the cylinder chamber 12. The communication port 162 is located at the inlet for air (A) of the bypass 16 to be communicated with the crankshaft chamber 13 as well as the intake port 14.

The fuel supply unit 20 is provided at the end portion 11 and used for supplying fuel, such as petrol, into the cylinder chamber 12. The fuel supply unit 20 comprises a fuel nozzle 21 and a high-pressure fuel pump 22. The fuel nozzle 21 is in contact with the cylinder chamber 12. The high-pressure fuel pump 22 is connected with the fuel nozzle 21. The rotary unit 30 is accommodated within the crankshaft chamber 13, and composed of a rotating part 31 as well as a linkage 32. The linkage 32 is pivotally connected with the rotating part 31 and moved therewith. The piston 40 is located within the cylinder chamber 12, and pivotally connected with the linkage 32. Moreover, the piston 40 is subjected to a reciprocating motion, by the rotating part 31, along the chamber axis 121 between TDC (L1) closest to the end portion 11 and a bottom dead center (BDC) (L2) farthest away from the end portion 11 (as shown in FIG. 1B). The oil baffle 50 is provided at the communication port 162, and operated for separating the crankshaft chamber 13 from the communication port 162 and the intake port 14. The oil baffle 50 may be a mesh or a grating, for example, for passing the air (A) while blocking the lubrication oil accommodated within the crankshaft chamber 13, so as to prevent the lubrication oil from entering the bypass 16. Lubrication required for the piston 40 on reciprocating motion and the rotary unit 30 is provided by the lubrication oil via a lubrication oil delivery mechanism. The throttle valve 60 is provided at the intake port 14. In this embodiment, the throttle valve 60 may be a non-return valve for controlling the passage of air (A). In the present invention, lubrication oil apt to form film rather than spray, such as lubrication oil having a higher viscosity index (abbreviated as VI), is preferably used. The lubrication oil delivery mechanism is the same as that used in a four-stroke engine, such as splash, circulating splash, pressure feed, combination of splash and pressure feed, for example.

The two-stroke compression ignition engine is operated as follows. Referring to FIG. 1B together, FIG. 1B is a cross-section diagram according to one embodiment of the present invention, in which the piston is located at BDC. The piston 40 is moved toward TDC (L1) from BDC (L2) along the chamber axis 121, such that a negative pressure environment is created within the crankshaft chamber 13 to open the throttle valve 60. Moreover, the air (A) is driven into the crankshaft chamber 13 from the intake port 14 through the oil baffle 50. The air (A) within the cylinder chamber 12 is gradually compressed and then heated to become high-temperature air during the movement of the piston 40 toward TDC (L1) (referring to FIG. 1A). As the piston 40 reaches TDC (L1), fuel is supplied to the cylinder chamber 12 by the fuel nozzle 21. The supplied fuel is ignited by the high-temperature air to produce an explosion. Further, a high-power propulsion and a combustion gas (B) are then produced by the explosion. The high-power propulsion is allowed for pushing the piston 40 to move toward BDC (L2) from TDC (L1) along the chamber axis 121. In this way, the air (A) within the crankshaft chamber 13 is pressed by the piston 40. Moreover, the air (A) is pushed to enter the bypass 16 through the communication port 162, and then into the cylinder chamber 12 from the bypass 16 through the scavenge port 161. Besides, the combustion gas (B) is pushed to be expelled through the exhaust port 15. Subsequently, the piston 40 is moved toward TDC (L1) from BDC (L2) again through rotation of the rotary unit 30, so as to carry out the reciprocating motion and then repeat the aforementioned operation. In this embodiment, the exhaust port 15 is extended outward from the cylinder chamber 12 along a passage axis perpendicular to the chamber axis 121. Further, an outflow direction of the air (A) at the scavenge port 161 is directed at the end portion 11 at a non-90° angle (a) (referring to FIG. 1B), i.e., non-right angle, with respect to the chamber axis 121. The angle (a) is in the range of 40 to 70 degrees. As such, the air (A) is allowed to enter the cylinder chamber 12 at this angle (a) without passing to the exhaust port 15 directly, so as to fill up the cylinder chamber 12 and then push the combustion gas (B) to be expelled.

Additionally, it should be noted that the oil baffle 50 is capable of blocking the lubrication oil from entering the bypass 16 along with the pushed air (A). Thus, the lubrication oil is blocked and left on the oil baffle 50. Further, the lubrication oil can be brought back to the crankshaft chamber 13 from the oil baffle 50 as the air (A) enters into the crankshaft chamber 13 from the intake port 14 through the oil baffle 50. The throttle valve 60 is closed while the piston 40 is moved toward BDC (L2) from TDC (L1), so as to ensure the air (A) entering the bypass 16.

In conclusion, the combustible gas mixture and the carburetor adopted in the conventional two-stroke petrol engine are rejected, by virtue of the characteristic of igniting fuel by high-temperature air due to compression in the present invention. In this way, the explosion is similarly produced to push the piston for the reciprocating motion, without the problem of air pollution owing to combustible gas mixture. Moreover, enhanced fuel efficiency far higher than that of the conventional two-stroke petrol engine is achieved. On the other hand, the lubrication oil is prevented from entering the cylinder chamber along with the air by the oil baffle provided for blocking the lubrication oil from entering the bypass. Therefore, the air entering the cylinder chamber is clean air, and consequently, the problem of pollution owing to lubrication oil in the conventional two-stroke petrol engine is also avoided.

What is claimed is:

1. A two-stroke compression ignition engine, comprising:
a casing, including an end portion, a cylinder chamber located near the end portion and defining a chamber axis, a crankshaft chamber connected with the cylinder chamber, an intake port communicated with the crankshaft chamber so as to supply an air into the crankshaft chamber, an exhaust port communicated with the cylinder chamber, and a bypass provided with two ends communicated with the crankshaft chamber and the cylinder chamber, respectively, and comprising a communication port communicated with the crankshaft chamber, in such a way that the air is possibly allowed to enter the cylinder chamber via the crankshaft chamber and the bypass;
a fuel supply unit provided at the end portion and used for supplying a fuel into the cylinder chamber;
a rotary unit, accommodated within the crankshaft chamber, comprising a rotating part as well as a linkage pivotally connected with the rotating part and moved therewith;
a piston located within the cylinder chamber, the piston being pivotally connected with the linkage so as to be subjected to a reciprocating motion along the chamber axis between a top dead center (TDC) closest to the end portion and a bottom dead center (BDC) farthest away from the end portion, the air within the cylinder chamber being compressed and then heated to become a high-temperature air during the movement of the piston toward the TDC, wherein the fuel is supplied to the cylinder chamber by the fuel supply unit as the piston reaches the TDC, and then ignited by the high-temperature air to produce an explosion to drive the piston for the reciprocating motion;
a lubrication oil accommodated within the crankshaft chamber, the lubrication oil providing lubrication required for the piston on the reciprocating motion and the rotary unit via a lubrication oil delivery mechanism; and
an oil baffle, provided at the communication port for passing the air while blocking the lubrication oil from entering the bypass, so as to prevent the lubrication oil from flowing to the cylinder chamber along with the air and then ensure that the air entering the cylinder chamber is clean.

2. The two-stroke compression ignition engine according to claim 1, wherein the oil baffle is a mesh or a grating.

3. The two-stroke compression ignition engine according to claim 1, wherein the lubrication oil delivery mechanism is selected from the group consisting of splash, circulating splash, pressure feed, and combination of splash and pressure feed.

4. The two-stroke compression ignition engine according to claim 1, wherein the bypass is located at an intake side with respect to the chamber axis, and comprises a scavenge port, communicated with the cylinder chamber, and the communication port, the communication port and the intake port being communicated with each other, while being both separated from the crankshaft chamber by the oil baffle.

5. The two-stroke compression ignition engine according to claim 4, wherein the exhaust port is located at an exhaust side opposite to the intake side with respect to the chamber axis.

6. The two-stroke compression ignition engine according to claim 5, wherein the exhaust port is extended from the cylinder chamber along a passage axis perpendicular to the chamber axis.

7. The two-stroke compression ignition engine according to claim 6, wherein an outflow direction of the air at the scavenge port is directed at a non-right angle formed with respect to the chamber axis, such that the air is allowed to enter the cylinder chamber at the angle without passing to the exhaust port directly.

8. The two-stroke compression ignition engine according to claim 7, wherein the angle is in a range of 40 to 70 degrees.

9. The two-stroke compression ignition engine according to claim 1, wherein the fuel supply unit further comprises a fuel nozzle in contact with the cylinder chamber, and a high-pressure fuel pump connected with the fuel nozzle.

10. The two-stroke compression ignition engine according to claim 1, further comprising a throttle valve provided at the intake port.
